(19) United States
(12) Patent Application Publication
(10) Pub. No.: US 2013/0113682 A1
(43) Pub. Date: May 9, 2013

(54) BIDIRECTIONAL DISPLAY FOR A PORTABLE ELECTRONIC DEVICE

(71) Applicants: Stephen D. Heizer, Houston, TX (US); Lee Warren Atkinson, Cypress, TX (US)

(72) Inventors: Stephen D. Heizer, Houston, TX (US); Lee Warren Atkinson, Cypress, TX (US)

(21) Appl. No.: 13/811,689

(22) PCT Filed: Oct. 5, 2010
(86) PCT No.: PCT/US10/51538

§ 371 Date: Jan. 23, 2013

(51) Int. Cl. G06F 3/14

(52) U.S. Cl. CPC G06F 3/1423
USPC 345/1.1

(57) ABSTRACT

Embodiments of the present invention disclose a bidirectional display for a portable electronic device. According to one embodiment, a bidirectional display assembly is configured to present an image on both a first side and a second side opposite the first side of the display assembly. Furthermore, a viewable display is provided on the first side and/or the second side of the display assembly based on a desired or selected operating mode.

### BACKGROUND

The emergence and popularity of mobile computing has made portable electronic devices, due to their compact design and light weight, a staple in today's marketplace. Many portable electronic devices employ a clam-shell type design such as most notebook computers, netbooks, tablet personal computers, and handheld devices. Generally, a clam-shell design consists of two housings connected together at a common end. In most cases, one housing is utilized to provide a viewable display to a user while a second housing includes an area for user input. As such portable electronic devices become more widespread in use, additional functionality is sought.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are three-dimensional perspective views of a portable electronic device according to an example of the present invention.

FIG. 2 is a simplified block diagram of the portable electronic device having a bidirectional display assembly according to an example of the present invention.

FIGS. 3A-3C illustrate a portable electronic device and bidirectional display assembly operating in a clamshell display mode according to an example of the present invention.

FIGS. 4A-4C illustrate a portable electronic device and bidirectional display assembly operating in a tablet display mode according to an example of the present invention.

FIGS. 5A-5D illustrate the pixel conversion method for the bidirectional display assembly according to an example of the present invention.

FIGS. 6A-6C illustrate the process for converting the portable electronic device having a bidirectional display assembly from a clamshell operating mode to a tablet operating mode according to an example of the present invention.

FIG. 7 illustrates the processing steps for operating the bidirectional display assembly according to an example of the present invention.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Generally, a tablet personal computer includes a display housing mounted on a base housing a combination of at least two rotating hinges so as to allow the viewable area of the display device to be rotated at least 180° into a second operating or viewing position. Namely, in the clamshell position the keyboard or physical buttons of the computer are uncovered and available for use. In the tablet position, the display housing is rotated laterally and downward such that the side opposite the viewable area of the display housing abuts and covers the keyboard or physical buttons of the computer. However, the arrangement of rotatable hinges, or hinge assembly, makes such notebooks undesirably bulky. Moreover, due to constant wear and tear of the mechanical hinges, the two housings may become disconnected after extended use. Therefore, there is a need in the art for a more intuitive tablet conversion method without the necessity of a rotating hinge assembly.

Embodiments of the present invention provide a bidirectional display assembly for a portable electronic device. According to one example, the bidirectional display assembly enables a user to view the display unit from both sides and when the portable electronic device is opened or closed. Furthermore, the display configuration afforded by examples of the present invention provides several advantages over prior solutions. For example, the display may be viewed from multiple directions and operating modes without requiring a mechanically rotating hinge. Still further, the display may be viewed simultaneously from two opposing sides for use in a classroom or similar learning environment.

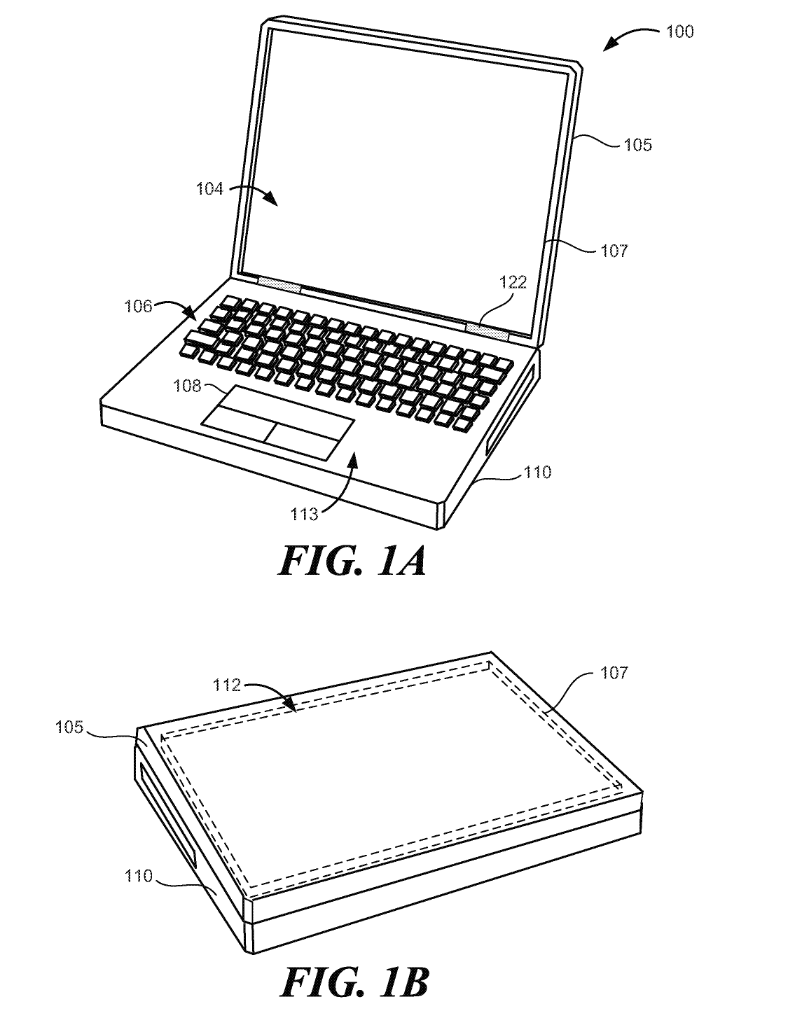

Referring now in more detail to the drawings in which like numerals identify corresponding parts throughout the views, FIGS. 1A and 1B are three-dimensional perspective views of a portable electronic device according to an example of the present invention. Portable computer 100 includes an upper housing 105 and a base housing 110 connected to each other via a hinge 122 or other pivot mechanism. The upper housing 105 includes electrical wiring adapted to provide images to a user via the display assembly 107. As shown in FIG. 1A, the base housing 110 includes a top surface side 113 having user input means such as a keyboard 106 and a touchpad 108. Still further, the upper housing 105 and display assembly 107 have a front surface side 104 and an opposite rear surface side 112 as shown in FIG. 1B.

FIG. 1B depicts the portable electronic device 100 in a closed position or tablet operating mode. As shown in the present example, the upper housing 105 is positioned vertically adjacent to the base housing 110 so that both housings 105 and 110 abut and are substantially congruent with one another. According to an example of the present invention, the display unit 107 is configured to provide a viewable display on the rear surface side 112 of the base housing 105 and display unit 107.

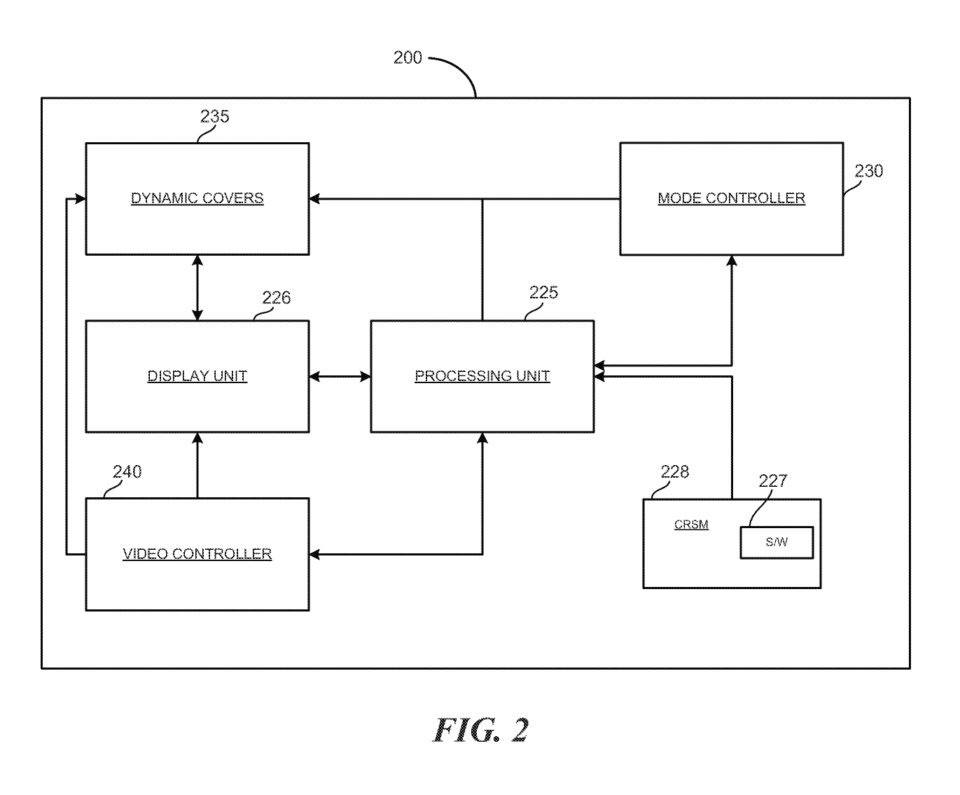

FIG. 2 is a simplified block diagram of the portable electronic device having a bidirectional display assembly according to an example of the present invention. As shown in this example, the system 200 includes a processing unit 225 coupled to a display unit 226, a mode controller 230, a video controller 240, and a computer-readable storage medium 228. The processing unit 225 represents a central processing unit configured to execute program instructions. Display unit 226 represents an electronic visual display or touch-sensitive display configured to display images and graphics to a user. Storage medium 228 represents volatile storage (e.g. random access memory), non-volatile store (e.g. hard disk drive, read-only memory, compact disc read only memory, flash storage, etc.), or combinations thereof. Furthermore, storage medium 228 includes software 227 that is executable by the processing unit 225 and, that when executed, causes the processing unit 225 to perform some or all of the functionality described herein.

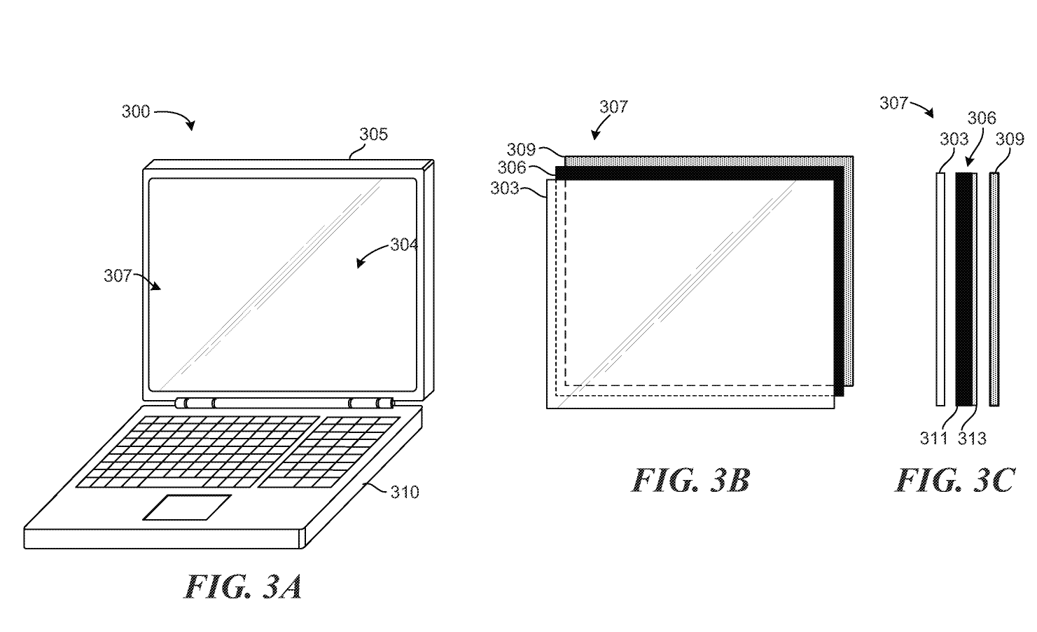

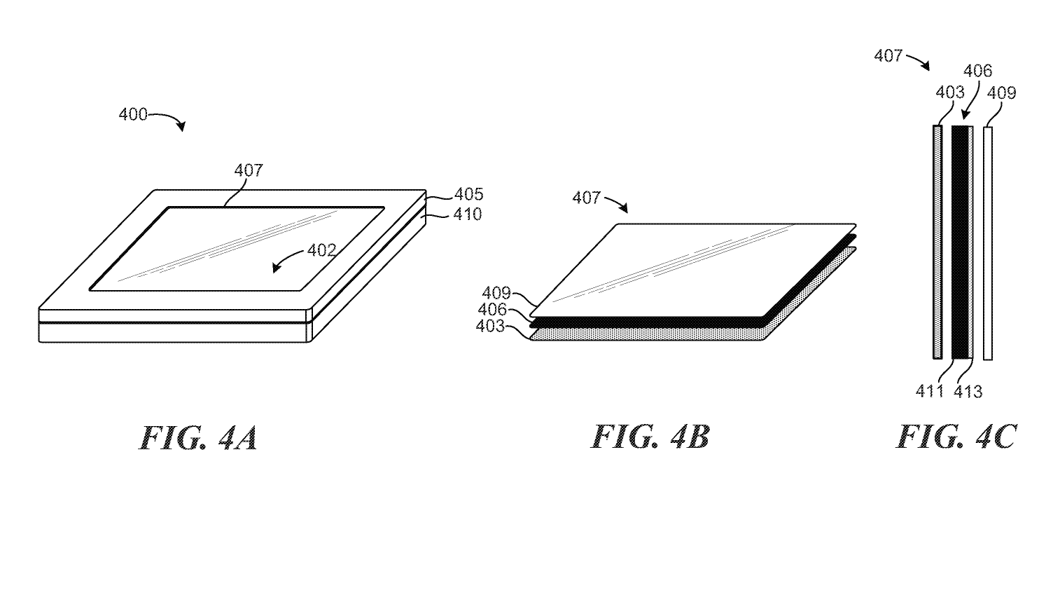

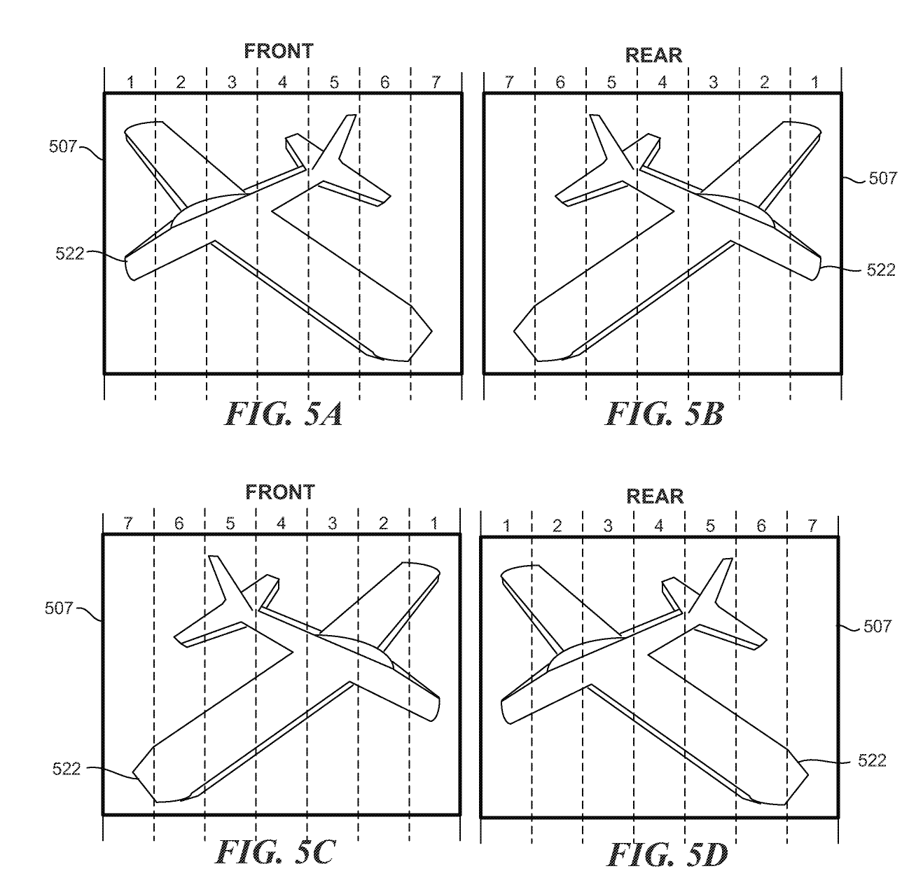

The video controller 240 is configured to reverse the association of pixel columns of an image output by the display unit while also enabling video scanning to occur from the left-to-right in a tablet operating mode and from right-to-left in clamshell operating mode as will be explained in more detail with reference to FIGS. 5A-5D. The mode controller 230 is configured to determine which operating mode the computer should be operating in (i.e. tablet or clamshell mode), establish the scan direction, and then enable the appropriate dynamic cover(s) 235 (the dynamic covers may also be enabled by the video controller 240). Although the mode controller 230 is shown as separate module from the processing unit, the mode controller 230 may be part of the processing unit 225, or its functions may also be performed by the processing unit 225. According to one example of the present invention, the operating mode may be determined by detecting the position of the display housing with respect to the base housing, user selection via a button or menu item from software running on electronic device, or any similar method. More particularly, when the mode controller 230 determines that the first housing is positioned away from the keyboard, or in a clamshell operating mode, then the mode selector 230 may automatically enable a back dynamic cover 235 such that only one side of the display unit 226 is viewable. Alternatively, the user may elect to have both sides of the display unit be viewable, therefore disabling the back dynamic cover 235 even when the electronic device is in the clamshell operating mode. On the other hand, when the mode controller determines that first housing is immediately adjacent and covering the keyboard of the base housing, then the video controller may enable a front dynamic cover 235 and disable the back dynamic cover 235 such that only the rear surface side of the display unit 226 is viewable. A more detailed description of this operation will be described in further detail with reference to FIGS. 3A-3C and FIGS. 4A-4C.

FIGS. 3A-3C illustrate a portable electronic device and bidirectional display assembly operating in a clamshell display mode according to an example of the present invention. As shown in FIG. 3A, the portable electronic device 300 includes a base housing 310 and an upper housing 305 for accommodating a display assembly 307. In the present example, the portable electronic device 300 is in a clamshell operating mode in which the display housing 305 is separated and positioned away from the base housing 310. FIG. 3B depicts individual components of the display assembly 307. As shown here, the display assembly 307 includes a front dynamic cover 303, a display unit 306, and a back dynamic cover 309. According to example shown in FIG. 30, the display unit 306 includes a visual electrical display 311 such as an emissive display like an organic light emitting diode (OLED) for example. Moreover, the visual electrical display 311 is formed on a transparent substrate 313. By forming the electrical display 311 on a transparent substrate 313, light is able to emanate from both sides of the display unit 306.

In the present example, the front dynamic cover 303 and the back dynamic cover 309 represent electrical films or filters formed of a liquid crystal diode material so that each may be selectively enabled depending on the viewing position of the display assembly 307. More specifically, both the front cover 303 and the back cover 309 are configured to receive power from mode controller or the processing unit so as to become opaque, or enabled such that light from the display unit 306 does not pass through. On the other hand, if power is not supplied to either the front dynamic cover 303 or the back dynamic cover 309, then they become transparent, or disabled such that light from the display unit 306 passes through. As such, the back dynamic cover 309 may serve as both a privacy filter and protective film by blocking undesirable viewing from the rear surface side of the display assembly 307. Furthermore, the front dynamic cover 303 and back dynamic cover 309 may also be manually controlled if viewing is desired from either or both sides of the display assembly 307. As shown in FIGS. 3B and 3C, when the portable electronic device 300 is operating in a clamshell operating mode, the front dynamic cover 303 is disabled (shown with white fill) while the back dynamic cover 309 is enabled (shown with patterned fill) so as to prevent light from rear side of the display unit 306 to pass through therefrom.

In an alternate example, the display assembly 307 may comprise of a pair of thin film transistor (TFT) elements 303 and 309 instead of dynamic covers, and a light guide as the display unit 306. Here, display unit 306 represents a light guide including a transparent acrylic LCD film 311 having a light emitting diode (LED) or cold cathode fluorescent light (CFFL) illuminant at the edge, followed by a color filter array 313. The TFT elements 303 and 309 may adjoin both sides of the display unit 306. According to one example, the video controller enables the appropriate TFT element 303 and 309 based on the operating mode of the portable electronic device. In such a configuration, the combination of the TFT elements 303 and 309 and the display unit 306 act as a programmable aperture by controlling light pass through from the display unit 306 on a pixel by pixel basis. Furthermore, since the viewable image of the present embodiment does not depend on the viewing position, the video controller does not need to reverse the scan direction of the display unit as in the embodiments utilizing an OLED-based display unit and dynamic covers.

FIGS. 4A-4C illustrate a portable electronic device and bidirectional display assembly operating in a tablet display mode according to an example of the present invention. As shown in FIG. 4A, the portable electronic device 400 includes a base housing 410 and an upper housing 405 for accommodating a display assembly 407. In the present example, the portable electronic device 400 is in a closed position or tablet operating mode in which the display housing 405 is positioned horizontally-adjacent and in close proximity to the base housing 410. FIG. 4B depicts individual components of the display assembly 407. As in the previous example, the display assembly 407 includes a front dynamic cover 403, a display unit 406, and a back dynamic cover 409. According to example shown in FIG. 4C, the display unit 406 comprises of an emissive display 411 formed on a transparent substrate 413 so as to enable light to emanate from both sides of the display unit 406. In contrast to the previous example shown in FIGS. 3A-3C, the portable electronic device 400 of FIGS. 4A-4C is operating in a tablet mode such that the viewable area of the display assembly 407 is on the rear surface side 402 of the display housing 405. In accordance therewith, the front dynamic cover 403 is enabled and opaque (patterned fill) so that light does not escape from the front side of the display unit 406, while the back dynamic cover 409 is disabled (white fill) so as to allow light to escape from the rear surface side 402 of the display assembly 407, thereby enabling viewing of images from the display unit 406 while the portable electronic device 400 is in a closed position (i.e. tablet operating mode). As detailed in the previous embodiment, a TFT-LCD combination may be used as the display assembly 407 instead of the dynamic covers and OLED display unit.

FIGS. 5A-5D illustrates the pixel conversion method for the bidirectional display assembly according to an example of the present invention. FIG. 5A depicts the view of a display assembly from the front surface side. In the present example, an image 522 of an airplane is displayed on the front surface side of the display assembly. Here, the image is divided into seven numbered pixel columns, (1)-(7). According to one example, when in the clamshell operating mode, the pixel columns associated with the image 522 are not reversed for viewing on the rear surface side, and therefore the image 522 will appear reversed when viewed from the rear side as shown in FIG. 5B. When operating in a tablet mode, however, the video controller or processing unit of the portable electronic device is configured to reverse the order of the pixel columns associated with the image 522 shown on the display assembly 507 such that the first pixel column (1) is positioned on the far right side of the display and the last pixel column (7) is positioned on the far left side of the display 507 as shown in FIG. 5C. When viewed from the rear surface side (i.e. tablet operating mode), the image 522 appears as intended (FIG. 5D) with the pixel columns correctly sequenced to match the image shown in FIG. 5A. Similarly, the scanning direction is changed by the video controller or processing unit form left-to-right scanning (i.e. clamshell operating mode) to right-to-left scanning (i.e. tablet operating mode). As such, images and video can be properly viewed on the display assembly as intended regardless of the operating mode of the portable electronic device. Still further, seven columns are simply shown for illustrating and simplification purposes only, and more than seven or less than seven pixel columns may be transposed by the video controller in accordance with examples of the present invention.

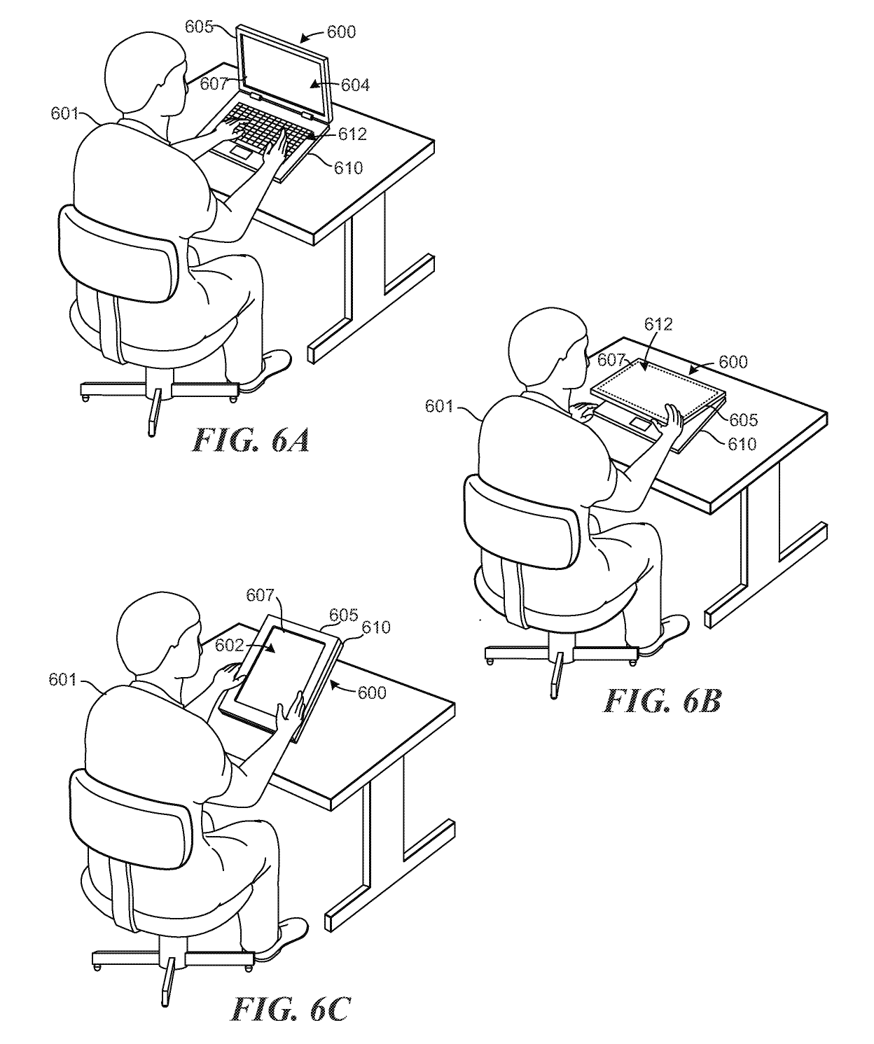

FIGS. 6A-6C illustrate the process for converting the portable electronic having a bidirectional display from a clamshell operating mode to a tablet operating mode according to an example of the present invention. As shown in FIG. 6A, the portable electronic device 600 is in a clamshell operating mode in which the display housing 605 is positioned away from the base housing 610. In the clamshell operating mode, the user 601 operates the input means 612 of the portable electronic device 600 while viewing the front surface side 604 of the display assembly 607. When converting from a clamshell operating mode to a tablet operating mode, the user 602 closes the portable electronic device 600 by rotating the display housing 605 inward so as to cover the input means 612 of the base housing as shown in FIG. 6B. As described above, when in the tablet operating mode the bidirectional display 607 is configured to be viewable from the rear side 602 as shown in FIG. 6C. Accordingly, the user 601 is able to quickly and easily convert the portable electronic device to a tablet operating mode without a complex rotating hinge assembly as in prior solutions.

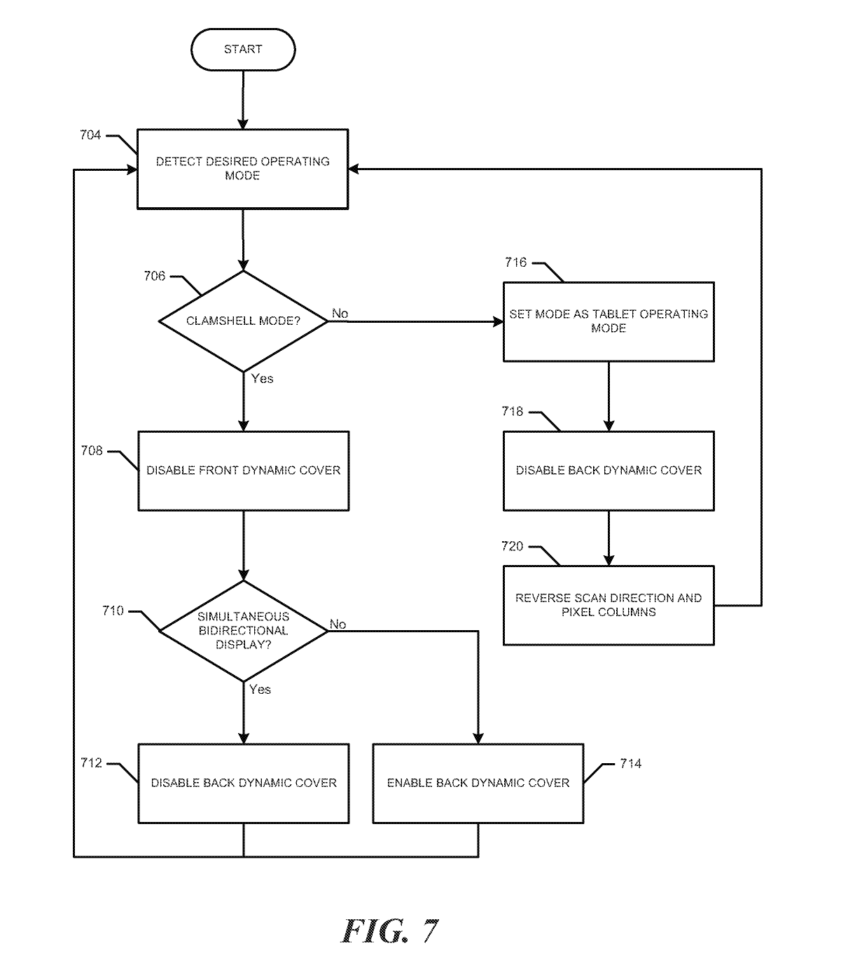

FIG. 7 illustrates the processing steps for converting the portable electronic device from a clamshell operating mode to a table operating mode according to an example of the present invention. In step 704, the desired operating or display mode of the portable electronic device is detected by the processing unit. As discussed above, the operating mode may be determined automatically by detecting the position of the display housing with respect to the base housing, or manually by user selection via a button or menu item from software running on electronic device, or any similar method. Based on the detection step, next in step 706, the processing unit determines if the portable electronic device should be in a clamshell operating mode or a tablet operating mode. If it is determined that the desired display or operating mode is “clamshell mode”, then in step 708 the processing unit or mode controller disables the front dynamic cover such that front surface side of the display assembly is viewable by the user. In step 710, the processing unit determines if simultaneous bidirectional display, or concurrent viewing from both sides of the display assembly, is desired by the user. If so, then in step 712, the processing unit or mode controller also disables the back dynamic cover so that the rear surface side of the display assembly may be viewed by a user in addition the front surface side. If not, then in step 714, the processing unit or mode controller enables the back dynamic cover so as to activate the opaque background filter and prevent light from escaping the rear side of the display assembly.

On the other hand, if the processing unit determines that the desired display or operating mode is “tablet mode”, then “tablet mode” is set as the operating mode in step 716. Next, in step 718, the back dynamic cover is disabled so as to allow light from the rear surface side of the display to pass through and provide a viewable display to the user. The front dynamic cover may also be enabled during this step, but since the front surface side of the display assembly is not visible when the portable electronic device is in a closed position (i.e. “tablet mode”), this operation may be omitted in order to save computing power. In step 720, the video controller or processing unit reverses the scan direction and pixel columns of the display unit associated with the display assembly as discussed in detail above with reference to FIGS. 5A-5D.

Embodiments of the present invention provide a bidirectional display assembly for a portable electronic device. In particular, the bidirectional display assembly includes a front dynamic cover and a back dynamic cover formed on opposite sides of display unit. According to one example, either the front dynamic cover or back dynamic cover is enabled in order to prevent viewing on one side of the display assembly while preventing viewing on the opposite side.

Moreover, several advantages are afforded by the configuration in accordance with examples of the present invention. For instance, the portable electronic of the present examples can be effortlessly converted from a clamshell operating mode to a tablet operating mode and without concern for housing disconnection issues caused by prolonged use of rotating mechanical hinges. In addition, the bidirectional display assembly of the present examples may be viewed concurrently by multiple users from both sides of the display assembly.

Furthermore, while the invention has been described with respect to exemplary embodiments, one skilled in the art will recognize that numerous modifications are possible. For example, although exemplary embodiments depict a notebook computer as the portable electronic device, the invention is not limited thereto. For example, the portable electronic device may be a netbook, a smartphone, or any other electronic device having a clamshell housing arrangement.

Furthermore, though examples describe and depict formation of both a front and back dynamic cover, bidirectional display functionality may also be provided using only the back dynamic cover. Thus, although the invention has been described with respect to exemplary embodiments, it will be appreciated that the invention is intended to cover all modifications and equivalents within the scope of the following claims.

What is claimed is:

1. A portable electronic device comprising:
a bidirectional display assembly configured to present an image on both a first side and a second side opposite the first side of the display assembly;
a first housing for accommodating the bidirectional display assembly;
a controller configured to selectively switch the display assembly between a first operating mode and a second operating mode;
wherein a viewable display is provided on the first side and/or the second side of the display assembly based on the selected operating mode.

2. The portable electronic device of claim 1, wherein the controller automatically switches to the first operating mode when the first housing is positioned away from the second housing, and
wherein the controller automatically switches to the second operating mode when the first housing is horizontally-adjacent to the second housing.

3. The portable electronic device of claim 2, wherein the bidirectional display assembly comprises:
an emissive display formed on a transparent substrate;
a front dynamic cover positioned on the first side of the emissive display and coupled to the controller, and
a back dynamic cover positioned on a second side of the emissive display and coupled to the controller.

4. The portable electronic device of claim 3, wherein the controller is configured to disable the front dynamic cover and enable the back dynamic cover when the display assembly is in the first operating mode.

5. The portable electronic device of claim 3, wherein the controller is configured to disable the back dynamic cover and enable the front dynamic cover when the display assembly is in the second operating mode.

6. The portable electronic device of claim 3, wherein the controller is configured to disable both the front dynamic cover and the back dynamic cover when the display assembly is in the first operating mode.

7. The portable electronic device of claim 1, wherein the first housing does not include a rotatable element for lateral rotation of the display device with respect to the base housing.

8. A method for operating a portable electronic device including a display housing and base housing, the method comprising:
detecting a desired operating mode for the portable electronic device;
providing a viewable display on a first surface side and/or a second surface side of a display assembly associated with the portable electronic device based on the detected operating mode, wherein the second surface side is a side opposite the first surface side.

9. The method of claim 8, further comprising:
determining the position of a display housing with respect to the base housing; and
automatically activating either a first operating mode or a second operating mode based on the determined position of the display housing and base housing.

10. The method of claim 9, wherein if the display housing is positioned away from the base housing, then the first operating mode is activated, and
if the display housing is horizontally-adjacent to the second housing, then the second operating mode is activated.

11. The method of claim 8, wherein the display assembly includes a front dynamic cover positioned on the first side of the display assembly and a back dynamic cover positioned on the second side of the display assembly.

12. The method of claim 11, wherein activating a first operating mode comprises:
disabling the front dynamic cover, and
enabling the back dynamic cover.

13. The method of claim 11, wherein activating a second operating mode comprises:
enabling the front dynamic cover, and
disabling the back dynamic cover.

14. A portable electronic device comprising:
a bidirectional display assembly configured to present an image on both a first side and a second side opposite the first side of the display assembly;
a first housing for accommodating the bidirectional display assembly;
a controller configured to selectively switch the display assembly between a first operating mode and a second operating mode;
wherein the bidirectional display assembly comprises:
an electric visual display;
a front dynamic cover positioned on the first side of the display and coupled to the controller; and
a background cover filter positioned on the second side of the display and coupled to the controller,
wherein a viewable display is provided on the first side and/or the second side of the display assembly based on the selected operating mode.

15. The portable electronic device of claim 14, wherein the controller is configured to disable the front dynamic cover and enable the back dynamic cover when the display assembly is in the first operating mode, and
wherein the controller is configured to disable the back dynamic cover and enable the front dynamic cover when the display assembly is in the second operating mode.
